(19) United States
(12) Patent Application Publication
(10) Pub. No.: US 2007/0200926 A1
(43) Pub. Date: Aug. 30, 2007

(54) Apparatus and method for generating panorama images

(76) Inventor: Yi Ta Chianglin, Taipei (TW)

Correspondence Address: Raymond Sun, 12420 Woodhall Way, Tustin, CA, 92782, US

(21) Appl. No.: 11/364,970

(22) Filed: Feb. 28, 2006

(51) Int. Cl. H04N 7/00

(52) U.S. Cl. 348/36; 348/218.1

(57) ABSTRACT

An apparatus and method for automatically generating panorama images is provided to facilitate the user operation. The apparatus comprises: a camera for rotating to a plurality of directions to shoot a corresponding partial image, and generating a panorama image according to the partial images; and a rotator for rotating the camera according to a control signal. The method comprises: generating two overlapping partial images; intercepting an image block from each partial image, wherein the image block contains an overlapping region of the partial images; performing edge detection on the image blocks; comparing the edge-detected image blocks to determine a range of the overlapping region; and assembling the partial images to generate the panorama image according to the range of the overlapping region.

### BACKGROUND OF INVENTION

1. Field of the Invention

The present invention relates in general to the generation of panorama images, and more particularly to an apparatus and method for automatically generating panorama images.

2. Description of the Prior Art

In prior art, if a user want to create a panorama image, he/she needs to rotate a digital camera manually to shoot two or more images at various directions, input the images to a computer, and then execute image-processing software to assemble the images. This solution is quite inconvenient and difficult for an ordinary user. On one hand, it requires a more professional shooting technique to assure a feasible image assembling; on the other hand, the user is required to operate the usually complicated image-processing software to perform the image assembling. Thus, the prior art does not provide an easy and convenient solution for the ordinary user to create the panorama image.

### SUMMARY OF INVENTION

In view of this, an object of the present invention is to provide an apparatus and method for automatically generating panorama images, thereby facilitating the user operation.

In this specification, a “partial image” means a portion of a panorama image.

According to one embodiment of this invention, an apparatus for generating a panorama image is provided. The apparatus comprises: a camera for rotating to a plurality of directions to shoot a plurality of corresponding partial images, and generating the panorama image according to the corresponding partial images; and a rotator for rotating the camera according to a control signal.

According to another embodiment of this invention, a method generating a panorama image is provided. The method comprises the steps of: generating two overlapping partial images; intercepting an image block from each of the partial images, wherein the image block contains an overlapping region of the partial images; performing edge detection on the image blocks; comparing the edge-detected image blocks to determine a range of the overlapping region; and assembling the partial images to generate the panorama image according to the range of the overlapping region.

### BRIEF DESCRIPTION OF THE DRAWINGS

FIG. 1 is a block diagram of a preferred embodiment of the apparatus for generating a panorama image according to the present invention.

FIGS. 2A and 2B are diagrams showing the viewing angle of a camera.

FIG. 3 shows an embodiment of how a digital camera rotates according to the present invention.

FIG. 4 is a flow chart of a preferred embodiment of the method for generating a panorama image according to the present invention.

FIG. 5A to 5E illustrate an example of how to run the flow of FIG. 4.

### DETAILED DESCRIPTION

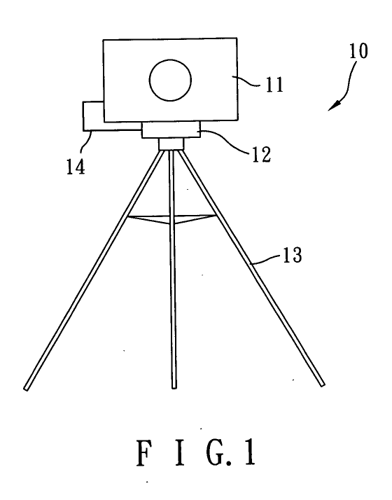

FIG. 1 is a block diagram of a preferred embodiment of the apparatus for generating a panorama image according to the present invention. As shown in FIG. 1, the apparatus 10 includes a digital camera 11, a rotator 12, and a camera stand 13. The rotator 12 is connected to the bottom of the digital camera 11, rotates the digital camera 11 to a plurality of directions according to a control signal 14, and shoots a plurality of corresponding partial images. The digital camera 11 assembles the partial images to generate the panorama image. The camera stand 13 is used to support the digital camera 11 and the rotator 12 and to prevent from shaking when the digital camera 11 shoots. The camera stand 13 can also adjust the digital camera 11 to a suitable height for shooting. In one embodiment, the digital camera 11 includes a memory (not shown) for storing the partial images. The memory is a built-in memory (with a faster processing rate, such as DRAM or SRAM) or a plug-in memory card (with a lower processing rate, such as CF (Compact Flash) card or SD (Secure Digital) card). In another embodiment, the rotator 12 contains a motor (not shown) for rotating the digital camera 11. Examples of the motor include a stepping motor, a servomotor, or a DC motor.

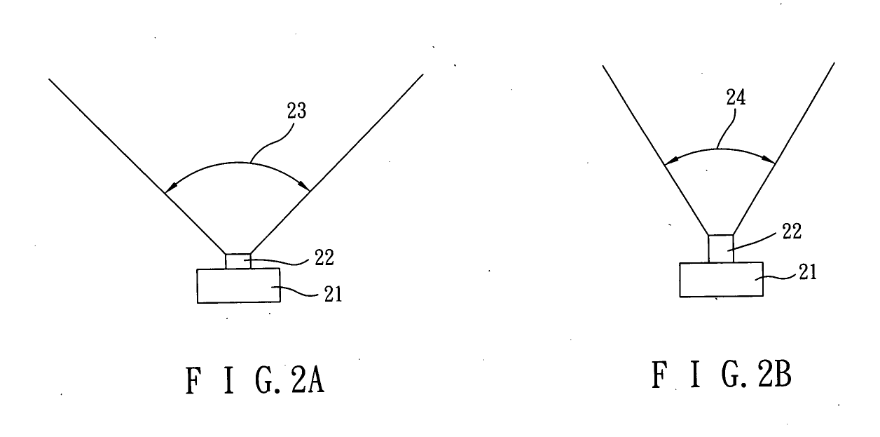

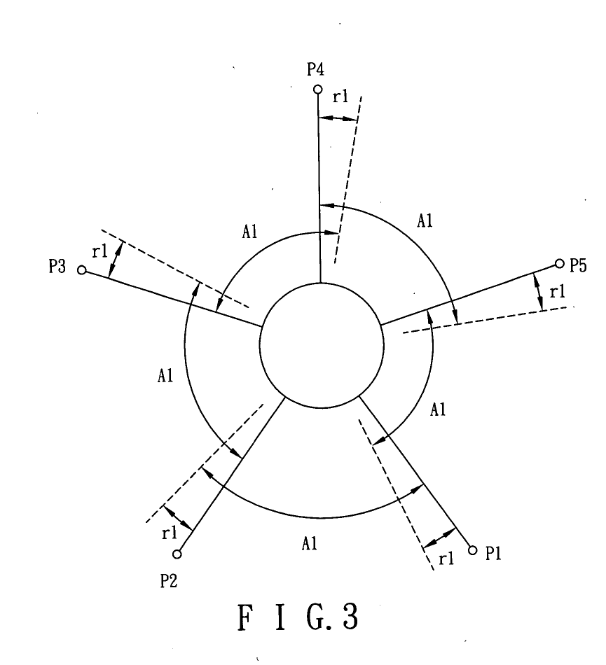

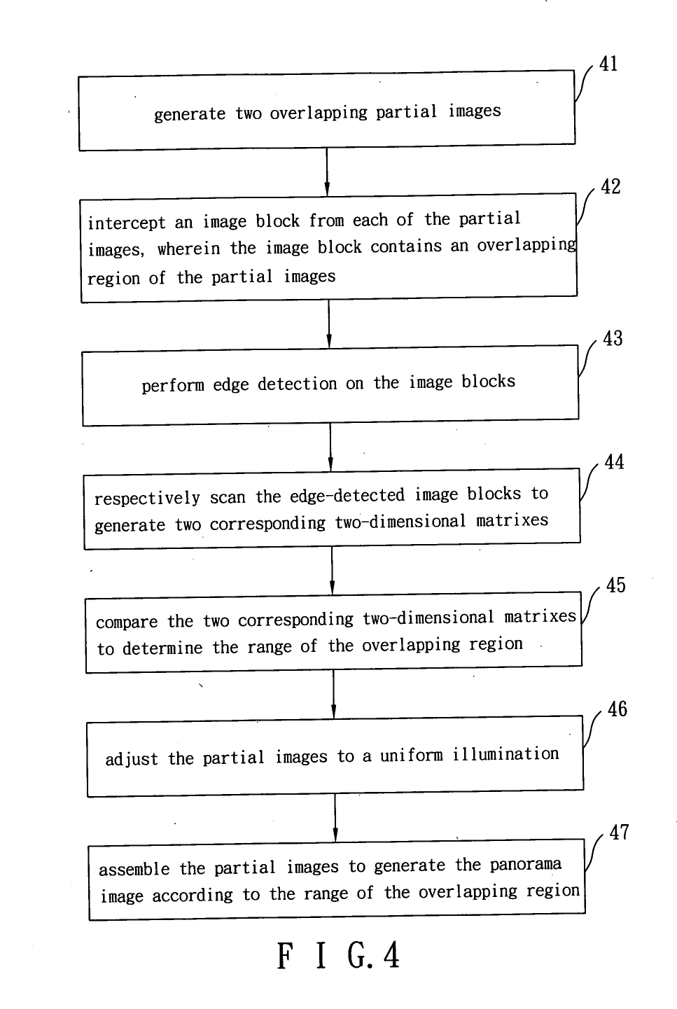

The width of the partial image is determined by a viewing angle of the digital camera 11. The viewing angle of a camera means the angle range which the camera can shoot, as shown in FIGS. 2A and 2B. The wider the viewing angle covers, the wider the partial image becomes. In FIG. 2A, when the zoom lens 22 of the camera 21 is set as “Wide”, the viewing angle 23 is wider; in FIG. 2B, when the zoom lens 22 is set as “Tele”, the viewing angle 24 is narrower. When shooting the partial images, the digital camera 11 rotates to the corresponding directions step by step, and the rotation angle is determined according to the viewing angle of the digital camera 11. In one embodiment, the rotation angle is smaller than the viewing angle of the digital camera 11, such that any two adjacent partial images can overlap each other for subsequent image assembling. In this embodiment, if the viewing angle of the panorama image to be generated is Aₜₒₜₐₗ, the viewing angle of the digital camera 11 is A₁, and a small angle r₁ from each adjacent side of any two adjacent partial images is reserved as an overlapping region, then the rotation angle of the digital camera 11 is A₁−r₁, and the required number of the partial images is equal to the integer part of (Aₜₒₜₐₗ-r₁)/(A₁−r₁) plus one (if (Aₜₒₜₐₗ-r₁)/(A₁−r₁) is just an integer, then “plus one” is not needed). Furthermore, if the viewing angle of the panorama image to be generated is the maximum 360 (i.e. Aₜₒₜₐₗ=360), then the required number of the partial images is equal to the integer part of 360/(A₁−r₁) plus one (if 360/(A₁−r₁) is just an integer, then “plus one” is not needed). FIG. 3 shows an embodiment of how the digital camera 11 rotates. As shown in FIG. 3, the viewing angle of the panorama image to be generated is assumed as 360, and the digital camera 11 rotates from P₁, via P₂, P₃, and P₄, to P₅. The rotation angle is A₁−r₁, and five partial images are generated.

In the embodiment of FIG. 1, the whole operation of the digital camera 11 (including the rotation to the directions, the shooting and assembling of the partial images) is guided in an automatically controlled manner. More specifically, the apparatus 10 further includes a control unit (not shown) for starting the digital camera 11 to automatically perform the whole operation mentioned above until the panorama image is generated. In one embodiment, the control unit is a start button on the digital camera 11. In another embodiment, the control unit is a remote controller, which enables a user to start the digital camera 11 a certain distance away. Thus, the user is provided more flexibility in operation (e.g. when he wants to include himself into the panorama image).

In the embodiment of FIG. 1, after being started, the digital camera 11 provides the control signal 14 to the rotator 12 via a wired or wireless interface, thereby controlling the rotation of the digital camera 11. One example of the wired interface is the USB interface. Examples of the wireless interface include Bluetooth, IrDA, RF (Radio Frequency) interface, WiFi, etc. In another embodiment, the control signal 14 is provided to the rotator 12 by a remote controller.

In one embodiment, the rotator 12 returns an acknowledge signal to the digital camera 11 when the digital camera 11 is rotated to one of the directions. When receiving the acknowledge signal, the digital camera 11 shoots the partial image corresponding to the direction.

In the embodiment of FIG. 1, after obtaining the partial images, the digital camera 11 runs a firmware program to perform edge detection thereon, so as to determine an overlapping region of every two overlapping partial images, and to assemble all the partial images to generate the panorama image according to the overlapping region. This will be described in detail later.

FIG. 4 is a flow chart of a preferred embodiment of the method for generating a panorama image according to the present invention. The preferred embodiment is applied to the apparatus 10 of FIG. 1. As shown in FIG. 4, the flow comprises the steps of:
41 generating two overlapping partial images;
42 intercepting an image block from each of the partial images, wherein the image block contains an overlapping region of the partial images;
43 performing edge detection on the image blocks;
44 respectively scanning the edge-detected image blocks to generate two corresponding two-dimensional matrixes;
45 comparing the two corresponding two-dimensional matrixes to determine the range of the overlapping region;
46 adjusting the partial images to a uniform illumination; and
47 assembling the partial images to generate the panorama image according to the range of the overlapping region.

In the step 41, the digital camera 11 is rotated to two different directions to shoot the two partial images. In the step 42, the width of the image block is determined according to the two directions of the step 41 and the viewing angle of the digital camera 11. In one embodiment, the viewing angle of the digital camera 11 is A₁, the included angle formed by the two directions (i.e. the rotation angle of the digital camera 11) is B₁, and a small angle A₁−B₁ from the adjacent side of each partial image is reserved as an overlapping region. Then, the ratio of the width of the image block to the width of the partial image must be larger than that of the viewing angle corresponding to the overlapping region to the viewing angle corresponding to the partial image (i.e., (A₁−B₁)/A₁), such that the image block can include the overlapping region.

In the step 46, a ratio of the average illumination of the overlapping region within both the image blocks is first estimated. Then, both the partial images are adjusted to a uniform illumination according to the estimated ratio. That is, the illumination of the darker (or brighter) partial image is increased (or decreased) to that of the brighter (or darker) one.

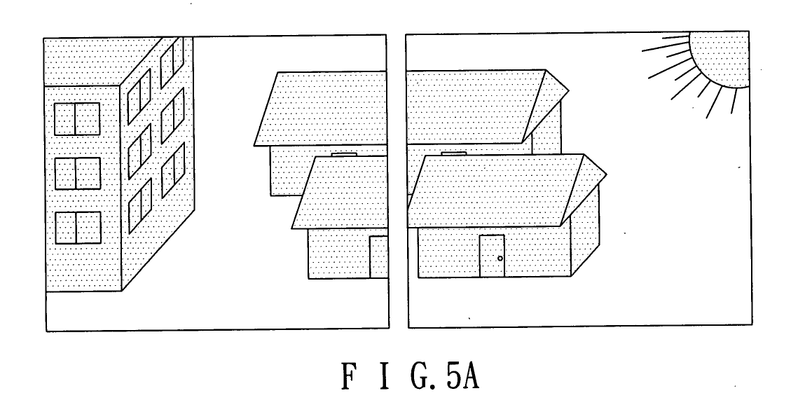

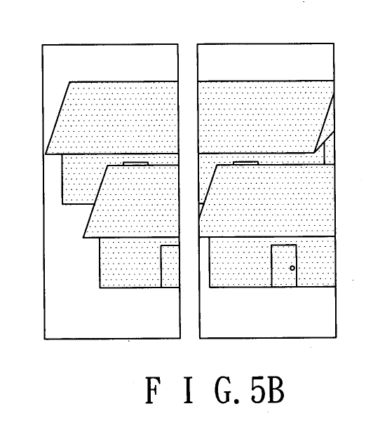

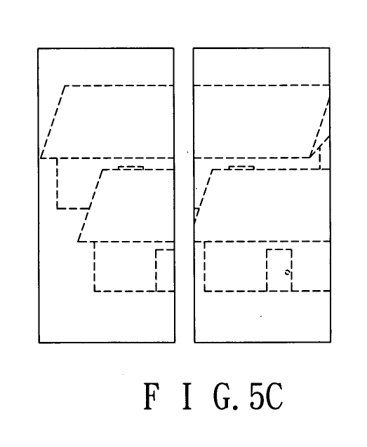

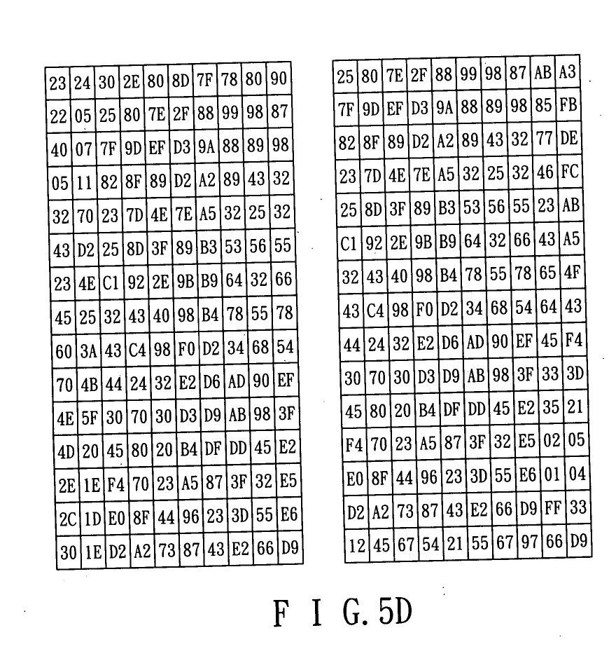

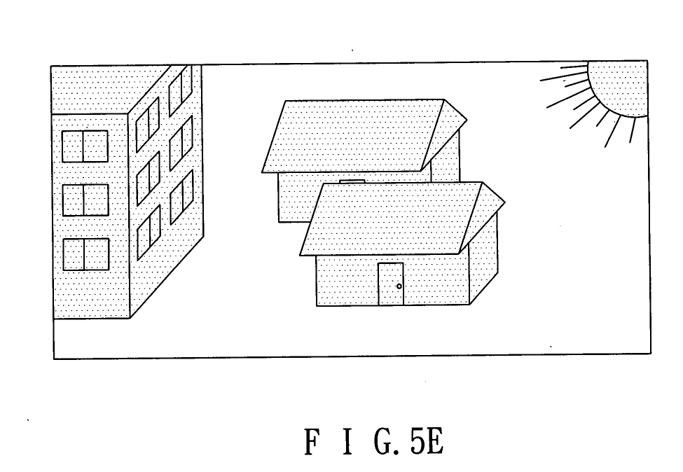

FIG. 5A to 5E illustrate an example of how to run the flow of FIG. 4.

FIG. 5A shows the two overlapping partial images generated in the step 41, and FIG. 5B shows the image blocks intercepted from the adjacent side of each partial image in the step 42. Next, the step 43 performs the edge detection on the image blocks, and the result is shown in FIG. 5C (i.e. the outline of the original images remains after the edge detection). In the step 44, the images in FIG. 5C are scanned to obtain two 10×15 matrixes as shown in FIG. 5D. Each entry in the matrixes represents a pixel value of the corresponding location in the images of FIG. 5C. In the step 45, both the matrixes are compared to determine the range of the overlapping region. If the location of each matrix entry is represented by coordinates (x,y), and the left-up corner of each matrix is represented as (0,0) (i.e. the entry at (0,0) of the left matrix is 23, and that of the right matrix is 25), then the comparison of both the matrixes shows that the block from (2,1) to (9,14) of the left matrix just overlaps that from (0,0) to (7,13) of the right matrix. The blocks from (2,1) to (9,14) of the left matrix and from (0,0) to (7,13) of the right matrix are then the overlapping region. It is notable that even though the pixel values within the overlapping region of both the partial images may be of a little variance, the pixel values within each horizontal or vertical line of the overlapping region of both the partial images are varied similarly to each other.

After the range of the overlapping region is determined, the step 46 will adjust both the partial images to a uniform illumination. Then, the step 47 assembles both the partial images according to the range of the overlapping region in each partial image, thereby generating the panorama image as shown in FIG. 5E.

In another preferred embodiment of the present invention, the method for generating a panorama image is applied to the case with more than two partial images. At this time, the number of the partial images is determined according to the viewing angle of the panorama image and the viewing angle of the camera, as mentioned above. In this preferred embodiment, the steps 41 to 45 of FIG. 4 are applied to any two overlapping partial images to determine an overlapping region thereof. Next, all the partial images are adjusted to a uniform illumination according to the original illumination of one of the partial images. Last, all the partial images are assembled to generate the panorama image according to the overlapping region of every two overlapping partial images. In one embodiment, the viewing angle of the panorama image is predetermined by a user.

By means of the embodiments described above, a user can utilize the present invention to automatically generate a panorama image by means of easy and convenient operation.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. An apparatus for generating a panorama image comprising:
a camera for rotating to a plurality of directions to shoot a plurality of corresponding partial images, and generating the panorama image according to the corresponding partial images; and
a rotator for rotating the camera according to a control signal.

2. The apparatus of claim 1, wherein each of the partial images corresponds to a viewing angle of the camera, and a rotation angle of the camera is determined according to the viewing angle.

3. The apparatus of claim 2, wherein the rotation angle is smaller than the viewing angle.

4. The apparatus of claim 1, wherein the control signal is provided by the camera.

5. The apparatus of claim 1, further comprising:
a remote controller for providing the control signal.

6. The apparatus of claim 1, wherein the rotator returns an acknowledge signal to the camera when rotating the camera to one of the directions.

7. The apparatus of claim 6, further comprising:
a camera stand for supporting the camera and the rotator.

8. The apparatus of claim 1, wherein the camera performs a firmware program to generate the panorama image.

9. The apparatus of claim 1, wherein the camera performs edge detection to determine an overlapping region of every two overlapping partial images, and assembles all the partial images to generate the panorama image according to the overlapping region of every two overlapping partial images.

10. The apparatus of claim 1, further comprising:
a control unit for starting the camera.

11. The apparatus of claim 10, wherein the control unit is a start button on the camera.

12. The apparatus of claim 10, wherein the control unit is a remote controller.

13. A method for generating a panorama image comprising:
generating two overlapping partial images;
intercepting an image block from each of the partial images, wherein the image block contains an overlapping region of the partial images;
performing edge detection on the image blocks;
comparing the edge-detected image blocks to determine a range of the overlapping region; and
assembling the partial images to generate the panorama image according to the range of the overlapping region.

14. The method of claim 13, wherein the partial images are generated by a camera shooting at two various directions.

15. The method of claim 14, wherein the camera is rotated to the two various directions in an automatically controlled manner.

16. The method of claim 14, wherein a width of the image block is determined according to the two various directions and a viewing angle of the camera.

17. The method of claim 13, wherein the step of comparing the edge-detected image blocks comprises:
respectively scanning the edge-detected image blocks to generate two corresponding matrixes; and
comparing the two corresponding matrixes to determine the range of the overlapping region.

18. The method of claim 13, further comprising:
adjusting the partial images to a uniform illumination.

19. A method for generating a panorama image comprising:
respectively rotating a camera to a plurality of directions to shoot a plurality of corresponding partial images, wherein the number of the partial images is determined according to a viewing angle of the panorama image and a viewing angle of the camera, and any two adjacent ones of the partial images overlap;
intercepting an image block, for every two overlapping partial images, from each of the two overlapping partial images, wherein the image block contains an overlapping region of the two overlapping partial images;
performing edge detection on the image blocks;
comparing the edge-detected image blocks to determine a range of the overlapping region; and
assembling all the partial images to generate the panorama image according to the range of the overlapping region.

20. The method of claim 19, wherein the viewing angle of the panorama image is predetermined by a user.
